(19) United States
(12) Patent Application Publication
(10) Pub. No.: US 2012/0063382 A1
(43) Pub. Date: Mar. 15, 2012

(54) BASE STATION DEVICE, TERMINAL DEVICE, WIRELESS COMMUNICATION SYSTEM AND TRANSMISSION METHOD

(75) Inventor: Yuta Seki, Kanagawa (JP)

(73) Assignee: PANASONIC CORPORATION, Osaka (JP)

(21) Appl. No.: 13/321,741

(22) PCT Filed: May 21, 2010
(86) PCT No.: PCT/JP2010/003438

§ 371 Date: Nov. 21, 2011

(30) Foreign Application Priority Data
May 29, 2009 (JP) 2009-130869

(51) Int. Cl. H04W 4/06

(52) U.S. Cl. 370/312

(57) ABSTRACT

Disclosed is a base station device that reduces efficiency drops in downlink radio resources due to retransmission while giving all terminals that have sent a retransmission request a retransmission opportunity. In the base station device (100), an allocator unit (114) creates a retransmission time slot for each fixed cycle, and data blocks having received a NACK are multiplexed and allocated to said retransmission time slots. By this means, retransmission can be guaranteed for all terminals (for UE#2-UE#4 in FIG. 3) that have sent a NACK. Further, because the retransmission data blocks are multiplexed and allocated to one time slot, frequency efficiency losses of downlink radio resources due to retransmission can be reduced.

### TECHNICAL FIELD

The present invention relates to a base station apparatus, a terminal apparatus, a radio communication apparatus and a transmission method in a multimedia broadcast and multicast service (MBMS) system.

### BACKGROUND ART

MBMS is a point-to-multipoint (p-t-m) transmission service in which a base station apparatus (hereinafter simply referred to as “base station”) transmits information data of, for example, multimedia broadcasting and broadcast service to a plurality of terminal apparatuses (hereinafter simply referred to as “terminal”). In MBMS, a base station performs transmission to a plurality of terminals by assigning the same data block to the same radio resource, so that, compared to unicast transmission for performing transmission by assigning a plurality of data blocks to a plurality of radio resources by point-to-point (p-t-p), MBMS has a feature that makes it possible to improve the efficiency of use of radio resources.

MBMS is stipulated by 3rd Generation Partnership Project (3GPP), a standards organization. In MBMS, the scheme for transmitting the same data block from a single base station is called “single-cell transmission,” and the scheme for performing transmission from a plurality of base stations is called “multi-cell transmission.”

Non-Patent Literature 1 stipulates applying hybrid-automatic repeat request (HARQ) as retransmission control in the single-cell transmission MBMS, as is the case with unicast transmission.

A terminal that receives an MBMS data block returns acknowledgement or negative acknowledgement (ACK or NACK) to a base station, depending on whether or not the terminal is able to decode the data block correctly. The base station retransmits the MBMS data block in response to which a NACK is detected.

According to the technique described in Non-Patent Literature 1, a plurality of terminals return an ACK or a NACK separately, so that the efficiency of use of radio resources in an uplink (uplink channel) lowers as the number of terminals increases.

Further, as the number of NACKs increases, frequent retransmission occurs, so that the efficiency of use of radio resources in a downlink (downlink channel) lowers. For example, when the frequency of NACKs at a terminal receiving an MBMS service at the cell edge is high, retransmission is performed to all terminals receiving the same service.

To solve the problem of the above-described technique, Non-Patent Literature 2 suggests the following methods of returning an ACK or a NACK.

An ACK is not returned, and only a NACK is returned using on-off keying (OOK).

A plurality of terminals return a NACK using the same radio resources in an uplink.

NACKs from a plurality of terminals are added to the same radio resources and are transmitted to a base station. The base station receives the NACKs that are added for a plurality of terminals, and determines whether or not to perform retransmission according to those NACKs. For example, the base station compares the power of NACKs against a threshold value, and according to the result of the comparison with the threshold value, determines whether or not to perform retransmission.

### CITATION LIST

### Non-Patent Literature

### NPL 1

3GPP TS 36.300 V8.7.0 (2008-12)

### NPL 2

Nokia, Nokia Siemens Networks, “MBMS single cell p-t-m related control signaling,” R1-080929, 3GPP TSG RAN WG1 Meeting #52

### SUMMARY OF INVENTION

### Technical Problem

However, the scheme described in Non-Patent Literature 2 has the following problem.

In the case where a base station determines whether or not to perform retransmission according to the comparison with a threshold value of power of NACKs that are added for a plurality of terminals, when NACKs are transmitted by the minority number of terminals, there is a likelihood that a condition where the data block that could not be decoded by the minority number of terminals is not retransmitted (hereinafter referred to as “Minority NACK”) occurs. NACK occurs stochastically. Therefore, minority NACK can occur in all terminals.

Generally speaking, because transmission information data is divided into a plurality of data blocks to be transmitted, minority NACK occurs, and when that data block is not retransmitted, the terminal cannot decode the transmission information data and has difficulty receiving the service.

As described above, because the scheme described in Non-Patent Literature 2 is a majority rule-based retransmission scheme, the data block that could not be decoded by the terminal is not retransmitted to that terminal for which minority NACK occurs, lowering service quality in that terminal.

It is therefore an object of the present invention to provide a base station apparatus, a terminal apparatus, a radio communication system, and a transmission method that can provide all terminals reporting a retransmission request with a chance of retransmission, and alleviate decrease of the efficiency of downlink channel radio resources due to retransmission.

### Solution to Problem

A base station apparatus according to the present invention employs a configuration to be a base station apparatus for transmitting multi-carrier data and/or broadcast data to a plurality of terminal apparatuses per data block at the same time, the base station apparatus including: a reception section that receives a retransmission request signal from each of the plurality of terminal apparatuses; an encoding and modulation section that encodes and modulates transmission data contained in data blocks that are different from each other, according to the received retransmission request signal, and outputs a plurality of data blocks for retransmission; a multiplexing section that multiplexes the plurality of data blocks for retransmission and outputs a multiplexed block; and an arrangement section that arranges the multiplexed block in a time slot for retransmission.

A terminal apparatus according to the present invention employs a configuration to include a reception section that receives a symbol sequence transmitted per data block at the same time from a base station apparatus; a slot demultiplexing section that demultiplexes a multiplexed block arranged in a time slot for retransmission, from the symbol sequence; a block demultiplexing section that demultiplexes the multiplexed block into a plurality of data blocks and outputs a data block for retransmission; a demodulation and decoding section that demodulates and decodes the data block for retransmission and outputs decoded data; an error detection section that detects whether an error of the decoded data is present or not present; and a transmission section that transmits a retransmission request signal according to a result of the error detection.

A radio communication system according to the present invention employs a configuration to include a base station apparatus that transmits multi-carrier data and/or broadcast data per data block to a plurality of terminal apparatuses at the same time and includes: a reception section that receives a retransmission request signal from each of the plurality of terminal apparatuses; an encoding and modulation section that encodes and modulates transmission data contained in data blocks that are different from each other, according to the received retransmission request signal, and outputs a plurality of data blocks for retransmission; a multiplexing section that multiplexes the plurality of data blocks for retransmission and outputs a multiplexed block; and an arrangement section that arranges the multiplexed block in a time slot for retransmission; and a terminal apparatus that includes: a reception section that receives a symbol sequence transmitted per data block at the same time from the base station apparatus; a slot demultiplexing section that demultiplexes the multiplexed block arranged in the time slot for retransmission, from the symbol sequence; a block demultiplexing section that demultiplexes the multiplexed block into a plurality of data blocks, and outputs a data block for retransmission; a demodulation and decoding section that demodulates and decodes the data block for retransmission, and outputs decoded data; an error detection section that detects whether an error of the decoded data is present or not present; and a transmission section that transmits the retransmission request signal according to a result of the error detection.

A transmission method according to the present invention employs a configuration to be a transmission method of transmitting multi-carrier data and/or broadcast data per data block to a plurality of terminal apparatuses at the same time, the method including the steps of: receiving a retransmission request signal from each of the plurality of terminal apparatuses; encoding and modulating transmission data contained in data blocks that are different from each other, according to the received retransmission request signal, and outputting a plurality of data blocks for retransmission; multiplexing the plurality of data blocks for retransmission, and outputting a multiplexed block; and arranging the multiplexed block in a time slot for retransmission.

### Advantageous Effects of Invention

According to the present invention, it is possible to provide all terminals reporting a retransmission request with a chance of retransmission, and alleviate decrease of the efficiency of downlink channel radio resources due to retransmission.

### BRIEF DESCRIPTION OF DRAWINGS

FIG. 1 shows a principal-part configuration of a transmitting base station according to Embodiment 1 of the present invention;

FIG. 2 shows a principal-part configuration of a receiving terminal according to Embodiment 1;

FIG. 3 shows an example of an arrangement of multiplexed blocks according to Embodiment 1;

FIG. 4 shows an example of an arrangement of multiplexed blocks according to Embodiment 1;

FIG. 5 shows yet another example of an arrangement of multiplexed blocks according to Embodiment 1;

FIG. 6 shows a principal-part configuration of a transmitting base station according to Embodiment 2 of the present invention;

FIG. 7 shows a principal-part configuration of a receiving terminal according to Embodiment 2;

FIG. 8 shows an example of an arrangement of multiplexed blocks according to Embodiment 2;

FIG. 9 shows a principal-part configuration of a transmitting base station according to Embodiment 3 of the present invention;

FIG. 10 shows a principal-part configuration of a receiving terminal according to Embodiment 3; and

FIG. 11 shows an example of an arrangement of multiplexed blocks according to Embodiment 3.

### DESCRIPTION OF EMBODIMENTS

Now, embodiments of the present invention will be described in detail with reference to the accompanying drawings.

### Embodiment I

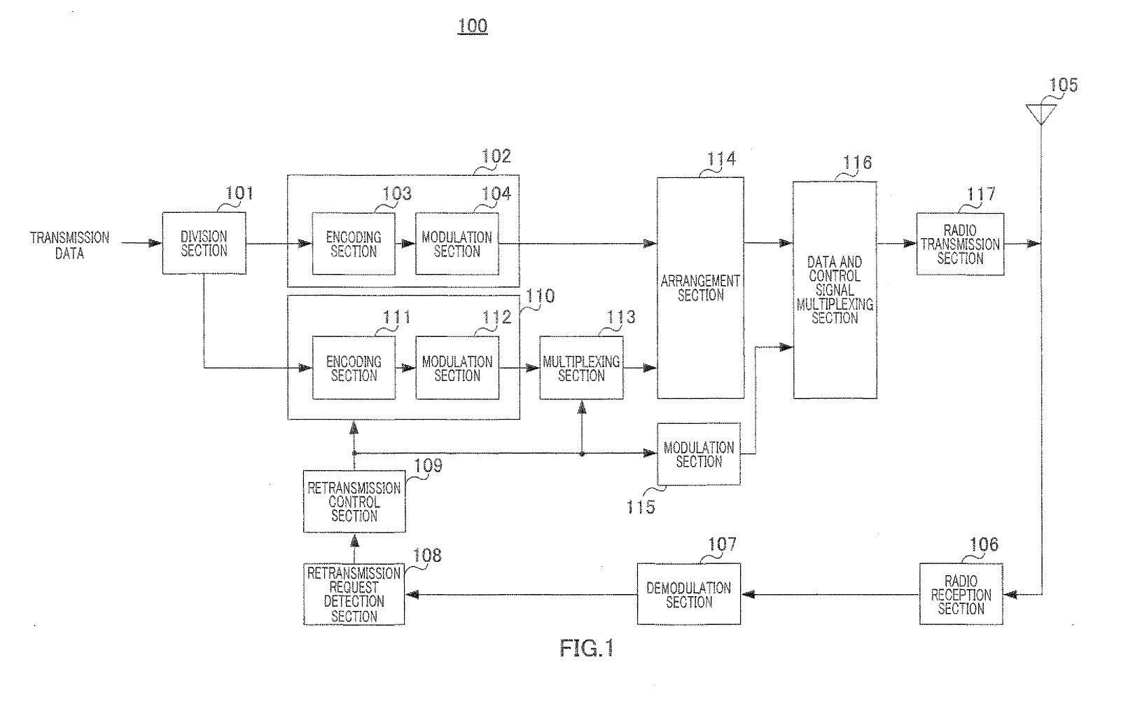

FIG. 1 shows a principal-part configuration of transmitting base station 100 according to the present embodiment.

Division section 101 receives as input transmission data and divides the transmission data into a plurality of blocks. Then, division section 101 outputs the plurality of data blocks obtained to encoding and modulation section 102 and encoding and modulation section 110.

Encoding and modulation section 102 includes encoding section 103 and modulation section 104, and encoding section 103 performs encoding processing on a data block containing transmission data for the initial transmission that is output from division section 101. Further, modulation section 104 modulates the encoded data output from encoding section 103 to generate a data block for the initial, transmission. Then, modulation section 104 outputs the generated data block for the initial transmission to arrangement section 114.

Radio reception section 106 receives a control signal (feedback information) transmitted from a receiving terminal, via antenna 105, performs reception processing, such as down conversion and A/D conversion, on that control signal, and outputs the reception-processed control signal to demodulation section 107. This control signal contains a response signal (ACK or NACK) and a data block number that are sent by feedback from the receiving terminal. According to the present embodiment, a response signal (ACK or NACK) is reported to base station 100, per data block.

Demodulation section 107 demodulates the control signal and outputs the demodulated control signal to retransmission request detection section 108.

From the control signal input from demodulation section 107, retransmission request detection section 108 detects the response signal (ACK or NACK), which is reported from each terminal, per data block. Then, retransmission request detection section 108 outputs information about the detected response signal and data block number to retransmission control section 109.

Retransmission control section 109 controls retransmission of the data block based on the response signal and the data block number input from retransmission request detection section 108. Specifically, retransmission control section 109 outputs the data block number in response to which a NACK is reported, which is input from retransmission request detection section 108, to encoding and modulation section 110. Further, retransmission control section 109 outputs the number of data block numbers in response to which a NACK is reported in a predetermined time, as multiplexing number N, to multiplexing section 113 and modulation section 115. Further, retransmission control section 109 outputs information about the data block number contained in the multiplexed block to modulation section 115. Further, in the case where arbitrarily setting a predetermined time for detecting the number of data block numbers in response to which a NACK is reported, retransmission control section 109 outputs information about that predetermined time to modulation section 115.

Encoding and modulation section 110 includes encoding section 111 and modulation section 112, and encoding section 111 maintains the transmission data output from division section 101, per data block, and performs encoding processing on the transmission data contained in the data block number reported from retransmission control section 109. Further, modulation section 112 modulates the encoded data output from encoding section 111 to generate a data block for retransmission. Then, modulation section 112 outputs the generated data block for retransmission to multiplexing section 113.

Multiplexing section 113 multiplexes N data blocks for retransmission based on multiplexing number N input from retransmission control section 109, to generate a multiplexed block. For the multiplexing method, multiplexing section 113 uses time division multiplexing, frequency division multiplexing, or code division multiplexing. Multiplexing section 113 outputs the generated multiplexed block to arrangement section 114.

Arrangement section 114 arranges the data block for the initial transmission and the multiplexed block in the time slots, and outputs the arranged data block for the initial transmission and multiplexed block (symbol sequence) to data and control signal multiplexing section 116. Specifically, arrangement section 114 provides a time slot for retransmission per predetermined period, and arranges a multiplexed block in that time slot for retransmission. The predetermined period is set based on the predetermined time for detecting the number of data block numbers in response to which a NACK is reported, in the above-described retransmission control section 109. The method of arrangement in arrangement section 114 will be described later. Arrangement section 114 outputs the arranged symbol sequence to data and control signal multiplexing section 116.

Modulation section 115 modulates multiplexing number N, the control information including information about the data block number contained in the multiplexed block and information about the period in which the time slot for retransmission is provided, and outputs the modulated control information to data and control signal multiplexing section 116.

Data and control signal multiplexing section 116 multiplexes the symbol sequence arranged in each time slot (data block for the initial transmission and multiplexed block) with the control information input from modulation section 115, in arrangement section 114, and outputs the multiplexed signal to radio transmission section 117.

Radio transmission section 117 performs transmission processing, such as DIA conversion, amplification, and up-conversion, on the signal input from data and control signal multiplexing section 116, and transmits the transmission-processed signal to receiving terminals at the same time, via antenna 105.

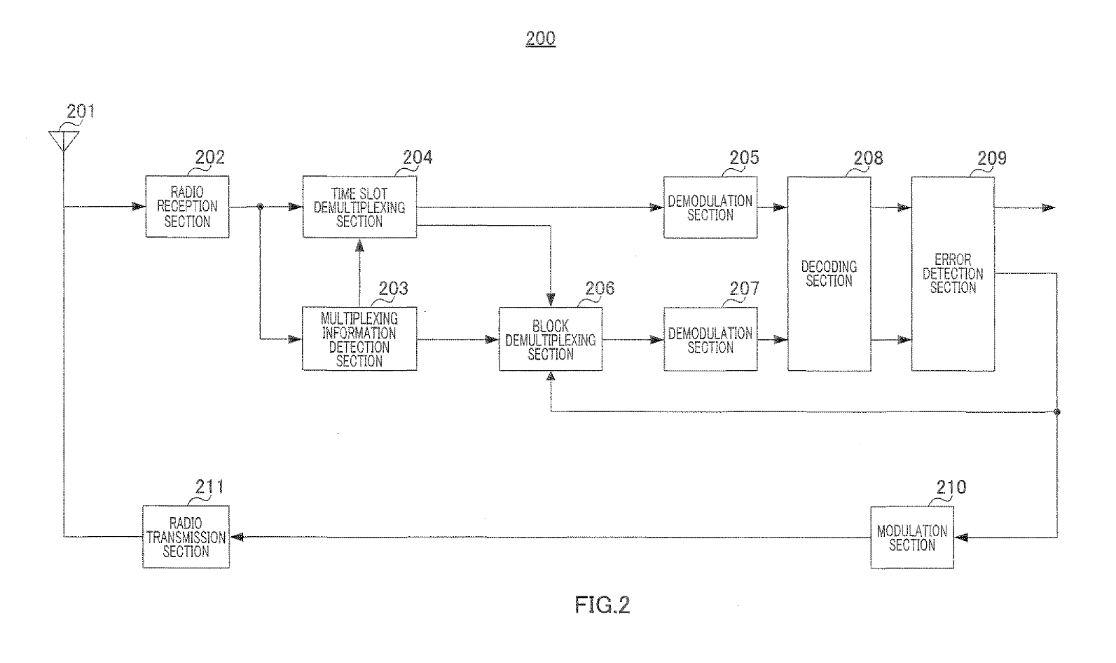

FIG. 2 shows a principal-part configuration of receiving terminal 200 according to the present embodiment.

Radio reception section 202 receives the signal transmitted from transmitting base station 100 via antenna 201, and performs reception processing, such as down conversion and AID conversion, on that signal. Then, radio reception section 202 outputs the reception-processed signal to multiplexing information detection section 203 and time slot demultiplexing section 204.

Multiplexing information detection section 203 extracts information about multiplexing number N of the data block for retransmission that is multiplexed with a multiplexed block, from the reception signal, and outputs information about extracted multiplexing number N and the data block number of the data block for retransmission, to block demultiplexing section 206. Further, upon detecting information about the period in which a time slot for retransmission is provided, from a reception signal, multiplexing information detection section 203 outputs the detected information about the period in which a time slot for retransmission is provided, to time slot demultiplexing section 204.

Time slot demultiplexing section 204 demultiplexes the data block for the initial transmission that is arranged in the time slot for the initial transmission and the multiplexed block arranged in the time slot for retransmission, from the reception-processed signal. Then, time slot demultiplexing section 204 outputs the data block for the initial transmission to demodulation section 205, and outputs the data block for retransmission to block demultiplexing section 206.

Demodulation section 205 demodulates the data block for the initial transmission input from time slot demultiplexing section 204, and outputs the demodulated data block to decoding section 208.

Block demultiplexing section 206 demultiplexes the multiplexed block arranged in the time slot for retransmission that is input from time slot demultiplexing section 204 into N data blocks for retransmission, based on multiplexing number N input from multiplexing information detection section 203, by associating that multiplexed block with the multiplexing method in multiplexing section 113 of base station 100.

Further, block demultiplexing section 206 extracts the data block number from which an error is detected, from the control signal input from error detection section 209 (described later), and, out of the demultiplexed data blocks for retransmission, outputs the data block for retransmission corresponding to the data block number from which an error is detected, to demodulation section 207.

Demodulation section 207 demodulates the data block for retransmission input from block demultiplexing section 206 (i.e. data block from which an error is detected in the past in error detection section 209), and outputs the demodulated data block to decoding section 208.

Decoding section 208 decodes each of the data blocks input from demodulation section 205 and demodulation section 207. For the decoding method, preferably, decoding section 208 performs, for example, HARQ processing per data block. That is, when decoding a data block, decoding processing is performed by synthesizing the data block that is received previously and from which an error is detected in error detection section 209 and the data block for retransmission that is received this time, so that it is possible to improve the encoding gain. Decoding section 208 outputs each of the decoded data blocks to error detection section 209.

Error detection section 209 performs error detection on the data block input from decoding section 208. Then, error detection section 209 generates a response signal per data block according the result of the error detection (whether an error is present or not present). When the error detection result is “error is present,” error detection section 209 generates a response signal containing a NACK and the data block number of the data block from which an error is detected. On the other hand, when the error detection result is “error is not present,” error detection section 209 generates a response signal containing an ACK and the data block number of the data block from which an error is not detected. Error detection section 209 outputs the control signal containing a NACK or an ACK and the data block number, to block demultiplexing section 206 and modulation section 210.

Modulation section 210 modulates the control signal input from error detection section 209, and outputs the modulated control signal to radio transmission section 211.

Radio transmission section 211 performs transmission processing, such as D/A conversion, amplification, and up-conversion, on the control signal, and transmits the transmission-processed control signal to transmitting base station 100 via antenna 201.

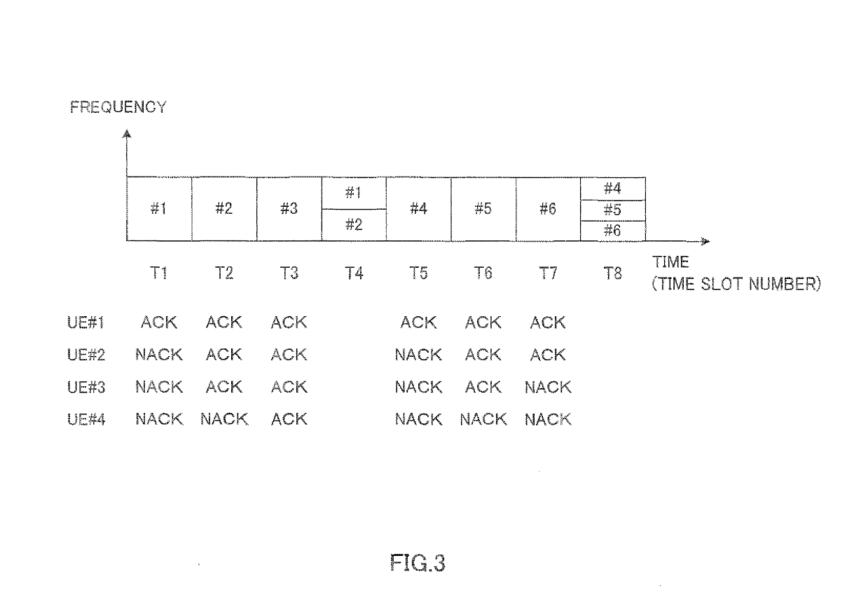

Next, the method of arranging time slots for retransmission according to the present embodiment will be described with reference to FIG. 3.

FIG. 3 shows an example of correspondence between data block numbers (#1 to #6) arranged in respective time slots (T1 to T8) and response signals reported from four terminals (UE #1 to UE #4, UE: user equipment) to respective data blocks.

In FIG. 3, time slots T1 to T3 and T5 to T7 are time slots for the initial transmission, and time slots T4 and T8 are time slots for retransmission, and FIG. 3 shows a case where time slots for retransmission are provided per four time slots. In this case, retransmission control section 109 sets the number of data block numbers in response to which a MACK is reported within a predetermined time of three time slots, as multiplexing number N.

For example, as shown in FIG. 3, when NACKs are reported from UEs #2, #3, and #4 in response to data block #1 that is transmitted in time slot for the initial transmission T1, a NACK is reported from UE #4 in response to data block #2 that is transmitted in time slot for the initial transmission T2, and ACKs are reported from all UEs #1 to #4 in response to data block #3 that is transmitted in time slot for the initial transmission T3, retransmission control section 109 sets multiplexing number N as two and outputs the multiplexing number of two to multiplexing section 113.

Multiplexing section 113 multiplexes data blocks #1 and #2 to generate a multiplexed block, and arrangement section 114 provides a time slot for retransmission in time slot T4 and arranges the multiplexed block in that time slot T4. With reference to FIG. 3, the multiplexed block arranged in time slot T4 shows a case where data blocks for retransmission of data blocks #1 and #2, are frequency multiplexed in multiplexing section 113, and the multiplexed block arranged in time slot T8 shows a case where data blocks for retransmission of data blocks #4, #5, and #6, are frequency multiplexed in multiplexing section 113.

As described above, according to the present embodiment, arrangement section 114 provides a time slot per predetermined period, and multiplexes and combines data blocks in response to which a NACK is sent by feedback to arrange the data blocks in that time slot for retransmission. By this means, it is possible to ensure retransmission to all terminals that have sent a NACK by feedback, that is, in the case of FIG. 3, UE #2 to UE #4. Further, data blocks for retransmission are arranged to be multiplexed in one time slot, it is possible to reduce the loss of the efficiency of frequency of downlink channel radio resources due to retransmission.

The arrangement pattern of time slots for the initial transmission and time slots for retransmission (hereinafter referred to as “time slot arrangement pattern”) is not limited to the pattern of FIG. 3, and it is possible to adopt any arrangement patterns as long as time slots for retransmission are provided periodically. In this ease, when terminal 200 knows the time slot arrangement pattern in advance, base station 100 can only report multiplexing number N of the multiplexed blocks to be arranged in the time slot for retransmission.

Further, it is possible to configure retransmission control section 109 to determine the encoding rate and the modulation level for generating retransmission data blocks according to multiplexing number N in multiplexing section 113, and output the determined encoding rate and modulation level to encoding and modulation section 110. For example, in the case shown in FIG. 3, because the number of data blocks for retransmission to be multiplexed in time slot T4 is two, retransmission control section 109 determines the encoding rates and modulation levels of data block #1 and data block #2 so that half of the frequency resources are assigned to each block. By this means, it is possible to efficiently use frequency resources that can be used in a time slot for retransmission and generate multiplexed blocks at the same time.

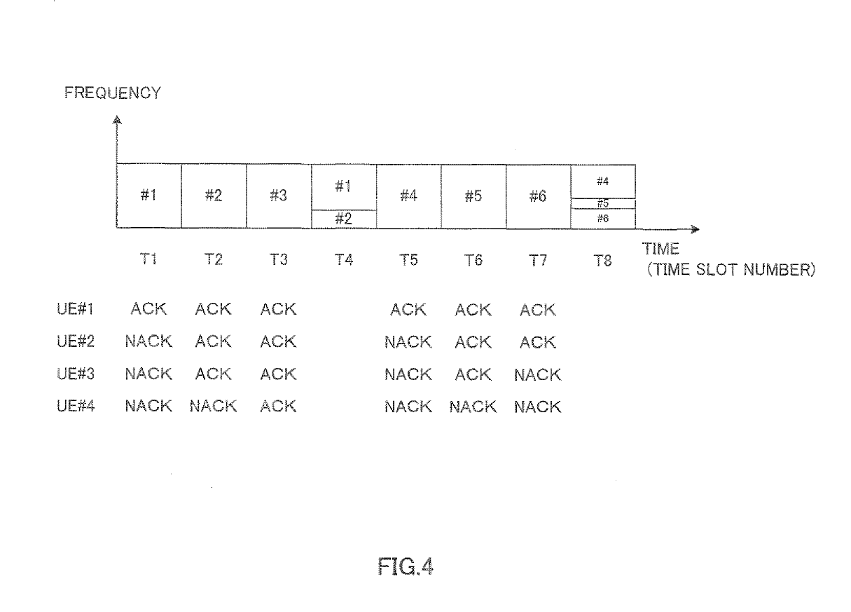

Further, retransmission control section 109 can assign more radio resources to transmission data of a data block having a larger number of NACKs reported, that is, transmission data of a data block having a larger number of NACKs reported from different terminals, out of data blocks to be multiplexed. For example, in the case where NACKs are reported from three UEs (#2, #3, and #4) in response to data block #1, and a NACK is reported from one UE (#4) in response to data block #2, the proportion of radio resources to be assigned to data block #1 is set greater than the proportion of radio resources to be assigned to data block #2, among radio resources in the time slot for retransmission (see FIG. 4). By this means, by assigning more radio resources in the time slot for retransmission to a data block having more retransmission requests, it is possible to improve the encoding gain or the modulation gain of the data block having many retransmission requests and prevent a retransmission request from being reported again. In other words, retransmission control section 109 can lower the encoding rate or the modulation level of transmission data of a data block having a larger number of NACKs reported, that is, transmission data of a data block having a larger number of NACKs reported from different terminals, out of data blocks to be multiplexed.

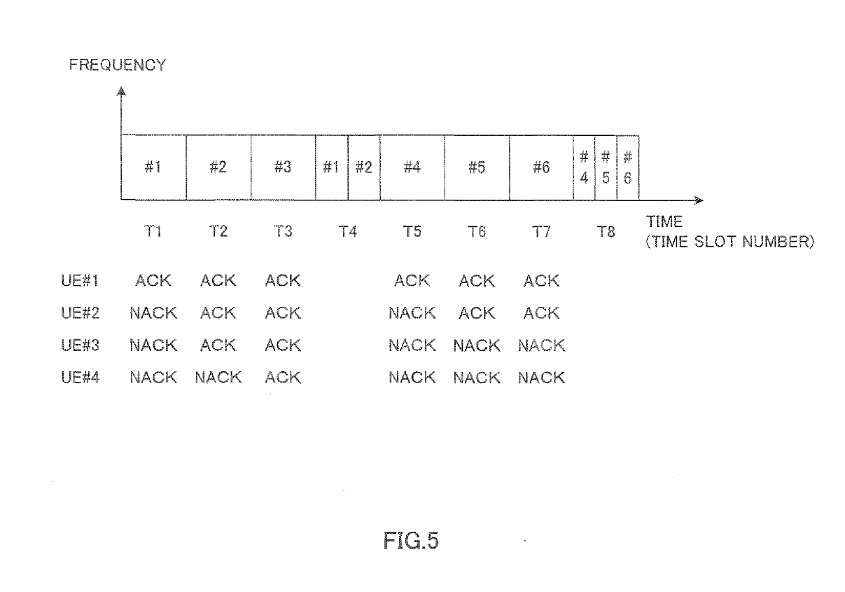

Although a case in which data blocks for retransmission are frequency multiplexed is shown in FIG. 3 and FIG. 4, it is possible to time multiplex a data block for retransmission, as shown in FIG. 5, and it is also possible to code multiplex a data block for retransmission.

### Embodiment 2

A case has been described with Embodiment 1 where a time slot for retransmission is provided per predetermined period, and data blocks in response to which a NACK is sent by feedback are multiplexed and combined to be arranged in that time slot for retransmission.

A case will be described with the present embodiment where, when the number of different data blocks in response to which a NACK is sent by feedback reaches predetermined number M, a time slot for retransmission is provided, and M data blocks in response to which a NACK is sent by feedback is multiplexed and combined to be arranged in that time slot for retransmission.

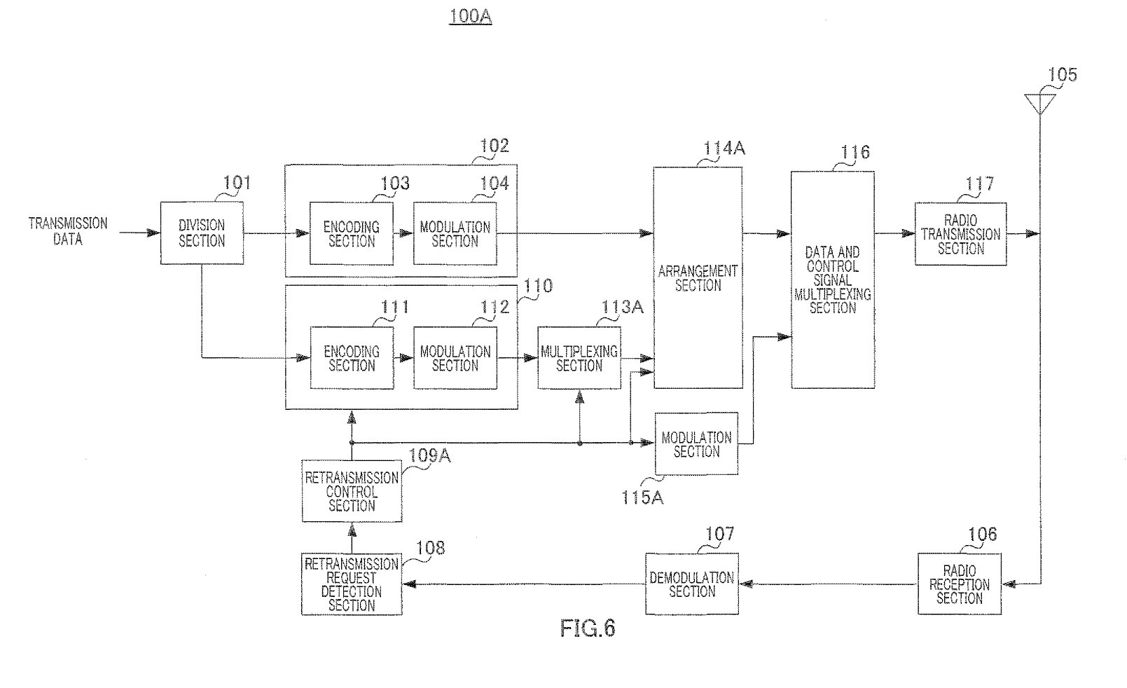

FIG. 6 shows a principal-part configuration of a transmitting base station according to the present embodiment. In the base station of FIG. 6 according to the present embodiment, parts that are the same as in FIG. 1 will be assigned the same reference numerals as in FIG. 1 and overlapping explanations will be omitted. Compared to base station 100 of FIG. 1, base station 100A of FIG. 6 includes retransmission control section 109A, multiplexing section 113A, arrangement section 114A, and modulation section 115A, instead of retransmission control section 109, multiplexing section 113, arrangement section 114, and modulation section 115.

Retransmission control section 109A controls retransmission of a data block based on the response signal and the data block number that are input from retransmission request detection section 108. Specifically, retransmission control section 109A outputs the data block number in response to which a NACK is reported, which is input from retransmission request detection section 108, to encoding and modulation section 110. Further, retransmission control section 109A counts the number of different data block numbers in response to which a NACK is reported, and when the number of different data block numbers in response to which a NACK is reported reaches predetermined number M, outputs a control signal for reporting that the number of different data block numbers in response to which a NACK is reported has reached predetermined number M, to multiplexing section 113A, arrangement section 114A, and modulation section 115A. Further, in the case where base station 100A sets the value of predetermined number M arbitrarily, retransmission control section 109A outputs information about predetermined number M to modulation section 115A.

Upon receiving the control signal from retransmission control section 109A, multiplexing section 113A multiplexes M data blocks for retransmission to generate a multiplexed block. For the multiplexing method, multiplexing section 113A uses time division multiplexing, frequency division multiplexing, or code division multiplexing. Multiplexing section 113A outputs the generated multiplexed block to arrangement section 114A.

Arrangement section 114A arranges the data blocks for the initial transmission and the multiplexed block in time slots, and outputs the arranged data blocks for the initial transmission and multiplexed block, to data and control signal multiplexing section 116. Specifically, upon receiving the control signal to report that the number of different block numbers in response to which a NACK is reported has reached predetermined number M from retransmission control section 109A, arrangement section 114A provides a time slot for retransmission, and arranges the multiplexed block in that time slot for retransmission. The method of arrangement in arrangement section 114A will be described later.

Modulation section 115A modulates the control information including information about the data block number contained in the multiplexed block and information about the position of the time slot for retransmission, and outputs the modulated control information to data and control signal multiplexing section 116. Further, when receiving as input information about predetermined number M from retransmission control section 109A, modulation section 115A performs modulation by including information about predetermined number M in the control information.

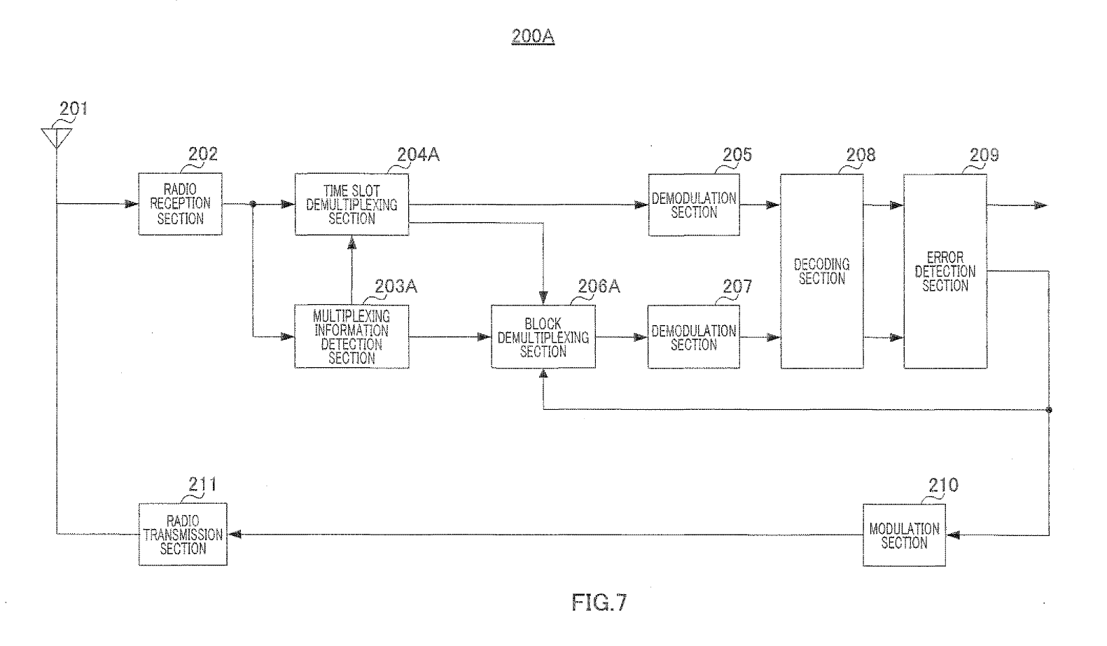

FIG. 7 shows a principal-part configuration of a receiving terminal according to the present embodiment. In the terminal of FIG. 7 according to the present embodiment, parts that are the same as in FIG. 2 will be assigned the same reference numerals as in FIG. 2 and overlapping explanations will be omitted. Compared to terminal 200 of FIG. 2, terminal 200A of FIG. 7 is configured to include multiplexing information detection section 203A, time slot demultiplexing section 204A, and block demultiplexing section 206A, instead of multiplexing information detection section 203, time slot demultiplexing section 204, and block demultiplexing section 206.

Multiplexing information detection section 203A detects the position of the time slot for retransmission in which a multiplexed block is arranged, from the control information contained in the reception signal, and outputs information about the detected position of the time slot for retransmission, to time slot demultiplexing section 204A. Further, in the case where information about predetermined number M is contained in the control information, multiplexing information detection section 203A outputs the information about predetermined number M to block demultiplexing section 206A.

Time slot demultiplexing section 204A demultiplexes the data block for the initial transmission that is arranged in the time slot for the initial transmission and the multiplexed block arranged in the time slot for retransmission, from the reception-processed signal, using information of the position of the time slot for retransmission reported from multiplexing information detection section 203A. Then, time slot demultiplexing section 204A outputs the data block for the initial transmission to demodulation section 205, and outputs the data block for retransmission to block demultiplexing section 206A.

Block demultiplexing section 206A demultiplexes the multiplexed block arranged in the time slot for retransmission that is input from time slot demultiplexing section 204A, into M data blocks for retransmission, based on predetermined multiplexing number M, by associating the multiplexed block with the multiplexing method in multiplexing section 113A of base station 100A. Block demultiplexing section 206A outputs the demultiplexed data block for retransmission to demodulation section 207.

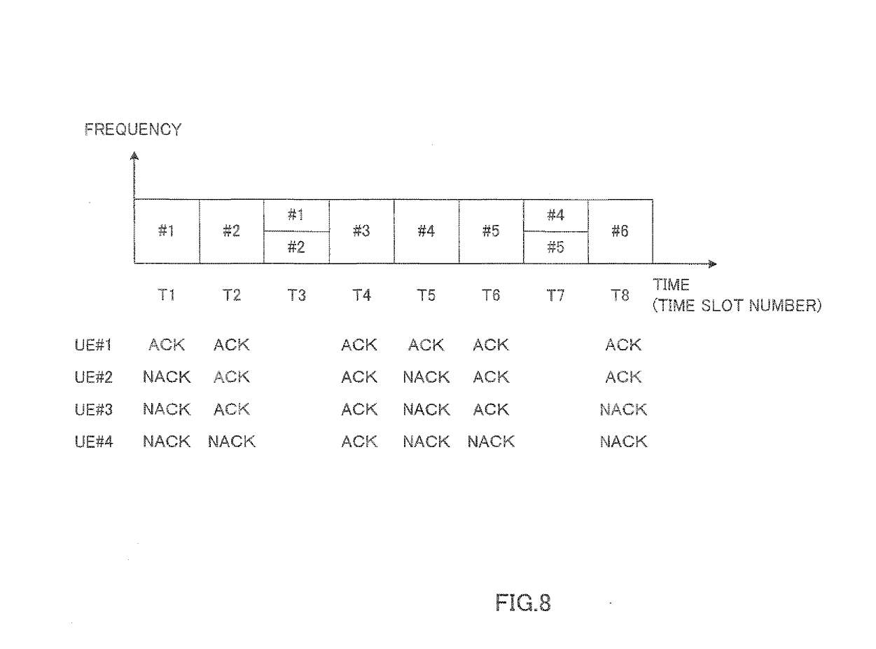

Next, the method of arranging time slots for retransmission according to the present embodiment will be described with reference to FIG. 8.

FIG. 8 shows an example of correspondence between data blocks arranged in respective time slots (T1 to T8) and response signals reported from four terminals (UE #1 to UE #4) in response to respective data block numbers (#1 to #6).

According to the present embodiment, arrangement section 114A provides a time slot for retransmission, when the number of different blocks in response to which a NACK is reported reaches predetermined number M.

In FIG. 8, time slots TI, T2, T4 to T6, and T8 are time slots for the initial transmission, and time slots T3 and T7 are time slots for retransmission, and FIG. 8 shows a case where time slots for retransmission are provided when the number of different blocks in response to which a NACK is reported is two.

Specifically, in the case where NACKs are reported from UEs #2, #3, and #4 in response to data block for the initial transmission #1 that is transmitted in time slot T1, and a NACK is reported from UE #4 in response to data block for the initial transmission #2 that is transmitted in time slot T2, retransmission control section 109A outputs a control signal for reporting that the number of different data block numbers in response to which a NACK is reported becomes a predetermined number of two, to multiplexing section 113A.

Multiplexing section 113A multiplexes data blocks #1 and #2 to generate a multiplexed block, and arrangement section 114A provides a time slot for retransmission in time slot T3 and arranges the multiplexed block in that time slot T3.

As described above, according to the present embodiment, in the case where the number of different data blocks in response to which a NACK is reported reaches predetermined number M, arrangement section 114A provides a time slot for retransmission, and multiplexes and combines the data blocks in response to which a NACK is sent by feedback to arrange the multiplexed and combined data block in that time slot for retransmission. By this means, it is possible to ensure retransmission to all terminals that have sent a NACK by feedback, that is, in the case of FIG. 8, UE #2 to UE #4. Further, data blocks for retransmission are arranged to be multiplexed in one time slot, it is possible to reduce the loss of the efficiency of frequency of downlink channel radio resources due to retransmission. Further, it is possible to set a limit to the number of data blocks to be multiplexed, so that, by setting predetermined number M as an appropriate value, it is possible to prevent the condition where radio resources in data blocks for retransmission is divided into a large numbers and radio resources to be assigned to each data block for retransmission becomes extremely scarce, making it possible to ensure appropriate radio resources for a data block for retransmission.

The multiplexing number of a data block for retransmission is not limited to two, and it is possible to provide base station 100A and terminal 200A with multiplexing number M in advance, or it is possible to report multiplexing number M from base station 100A to terminal 200A. cl Embodiment 3

A method of assigning radio resources to a data block for retransmission that is to be arranged by being multiplexed in a time slot for retransmission, will be described with the present embodiment.

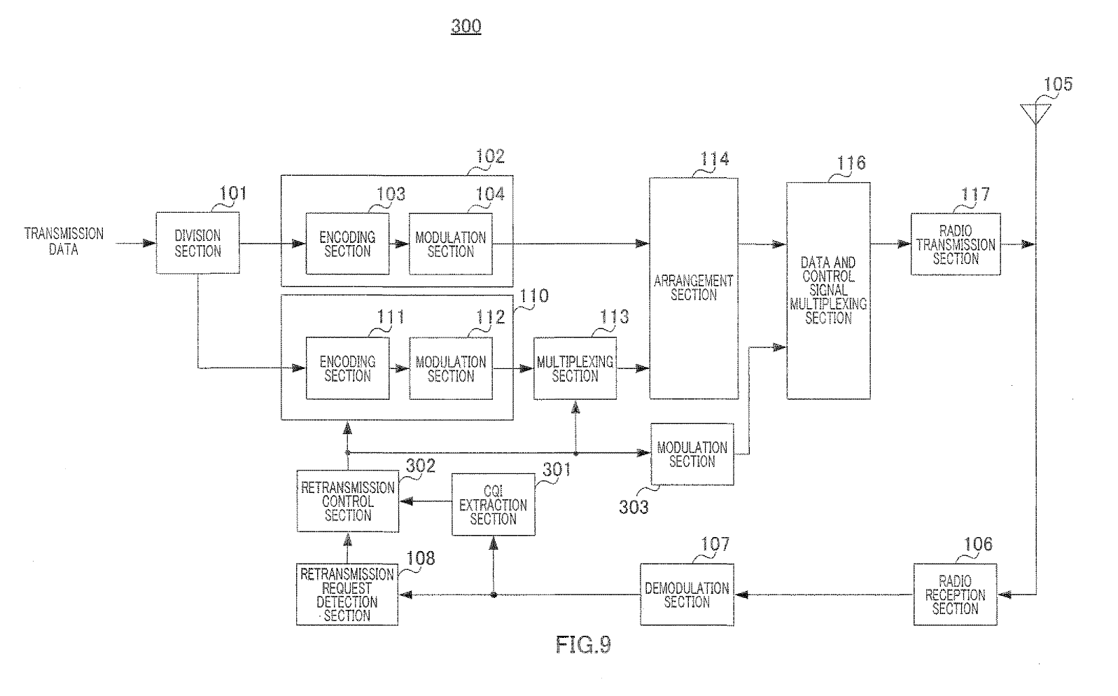

FIG. 9 shows a principal-part configuration of transmitting base station 300 according to the present embodiment. In base station 300 of FIG. 9 according to the present embodiment, parts that are the same as in FIG. 1 will be assigned the same reference numerals as in FIG. 1 and overlapping explanations will be omitted. Compared to base station 100 of

FIG. 1, base station 300 of FIG. 9 is configured to include retransmission control section 302 and modulation section 303, instead of retransmission control section 109 and modulation section 115, and add channel quality indicator (CQI) extraction section 301.

CQI extraction section 301 extracts channel quality indicator (CQI) of each terminal from demodulated control information, and outputs information about the extracted CQI to retransmission control section 302.

Retransmission control section 302, in the same way as retransmission control section 109, controls retransmission of a data block based on the response signal and the data block number input from retransmission request detection section 108. Further, retransmission control section 302 determines the encoding rate and the modulation level for generating a data block for retransmission and radio resources to which that data block for retransmission is assigned, so as to assign the data block for retransmission of the data block in response to which a NACK is reported, to radio resources having better channel quality of a terminal that has returned that NACK, based on the channel quality indicator (CQI) of the terminal that has reported the NACK. Retransmission control section 302 outputs information about the determined encoding rate and modulation level to encoding and modulation section 110, and outputs information about the radio resources to which a data block for retransmission is to be assigned, to multiplexing section 113 and modulation section 303.

In addition to the operation of modulation section 115, modulation section 303 performs modulation by including information about radio resources to which a data block for retransmission is to be assigned in the control information.

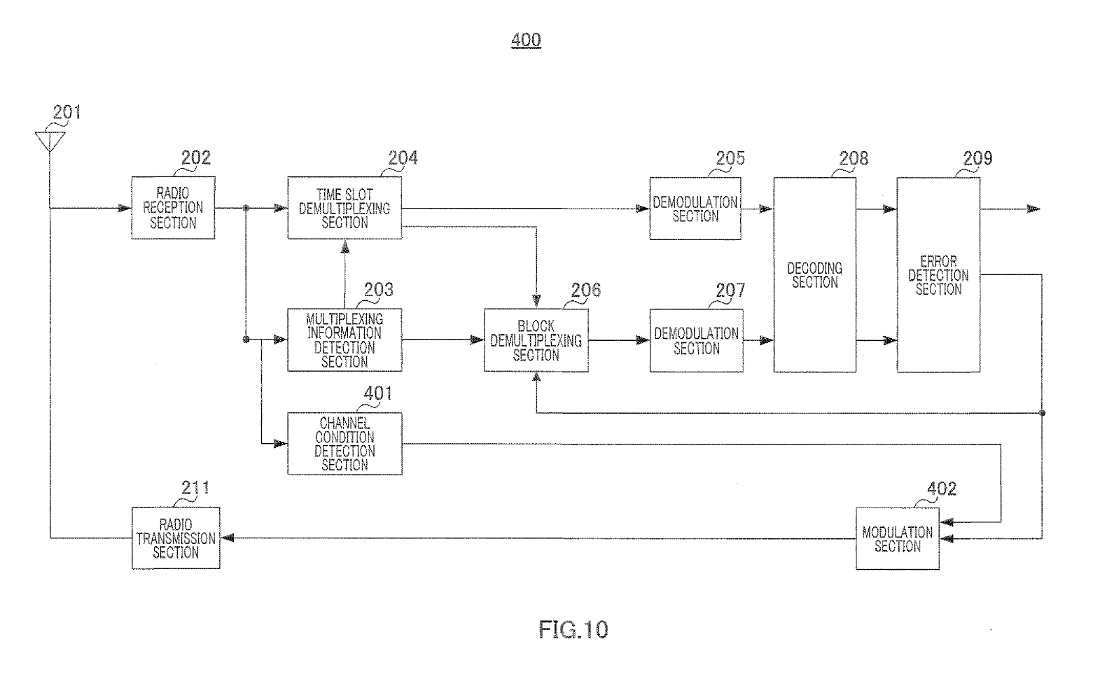

FIG. 10 shows a principal-part configuration of a transmitting terminal according to the present embodiment. In terminal 400 of FIG. 10 according to the present embodiment, parts that are the same as in FIG. 2 will be assigned the same reference numerals as in FIG. 2 and overlapping explanations will be omitted. Compared to terminal 200 of FIG. 2, terminal 400 of FIG. 10 is configured to include modulation section 402 instead of modulation section 210, and add channel condition detection section 401.

Channel condition detection section 401 detects the condition of a channel using the control signal transmitted from base station 300, and outputs the detected channel condition to modulation section 402 as a channel quality indicator (CQI).

Modulation section 402 modulates the control signal input from error detection section 209 and the channel quality indicator (CQI) input from channel condition detection section 401, and outputs the modulated control signal to radio transmission section 211.

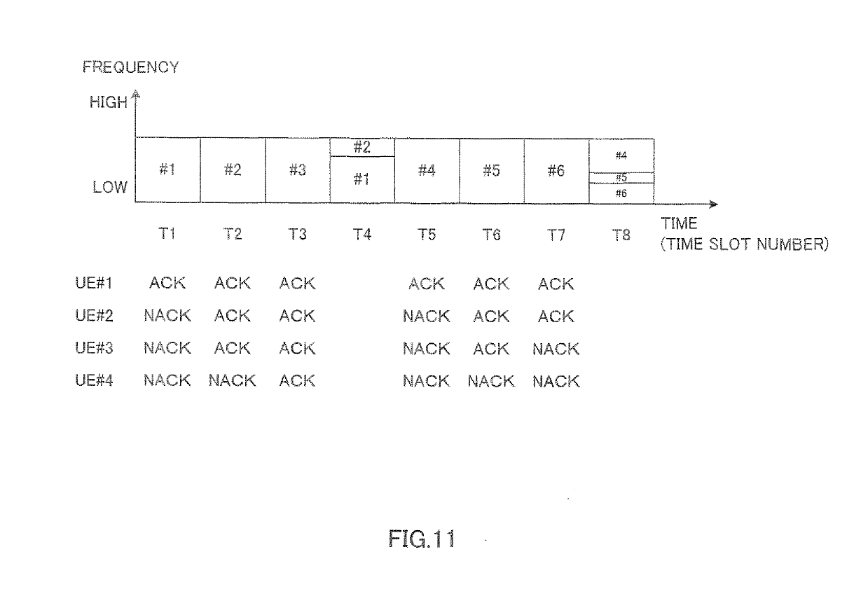

Next, a method of assigning radio resources to a data block for retransmission according to the present embodiment, will be described with reference to FIG. 11.

FIG. 11 shows an example of correspondence between data blocks arranged in respective time slots (T1 to T8) and response signals reported from four terminals (UE #1 to UE #4) in response to respective data block numbers (#1 to #6).

In FIG. 11, time slots T1 to T3 and T5 to T7 are time slots for the initial transmission, and time slots T4 and T8 are time slots for retransmission, and FIG. 10, in the same way as FIG. 3, shows a case where time slots for retransmission are provided per predetermined period, per four time slots.

In this case, in the same way as in FIG. 3, consider a case where NACKs are reported from UEs #2, #3, and #4 in response to data block #1 that is transmitted in time slot for the initial transmission T1, and a NACK is reported from UE #4 in response to data block #2 that is transmitted in time slot for the initial transmission T2, and ACKs are reported from all UEs #1 to #4 in response to data block #3 that is transmitted in time slot for the initial transmission T3.

Retransmission control section 302 determines the encoding rate and the modulation level for generating a data block for retransmission and radio resources for assigning that data block for retransmission, so as to assign the data block for retransmission of the data block in response to which a NACK is reported, to radio resources having good channel quality of a terminal that has returned that NACK, based on the channel quality indicator (CQI) of the terminal that reports the NACK in the time slot interposed between the time slots for retransmission.

For example, in the case where, in time slots T1 to T3, the channel quality of UEs #2 and #3 that have reported a NACK in response to data block #1 is better as the frequency decreases, and the channel quality of UE #4 that has reported a NACK in response to data block #2 is better as the frequency increases, retransmission control section 302 assigns data block #1 to the low-frequency area, and assigns data block #2 to the high-frequency area, in the radio resources of the time slot for retransmission (see FIG. 11), and outputs information about radio resources to which the data block for retransmission will be assigned, to multiplexing section 113.

Further, in the case where, in time slots T5 to T7, the channel quality of UE #3 that has reported a NACK in response to data block #5 is better nearer the center of the frequency, and the channel quality of UE #4 that has reported a NACK in response to data block #6 is better as the frequency decreases, retransmission control section 302 assigns data block #5 to the center area of frequency, assigns data block #6 to the low-frequency area, and assigns the remaining data block #4 to the high-frequency area, in the radio resources of the time slots for retransmission (see FIG. 11), and outputs information about radio resources to which the data block for retransmission will be assigned, to multiplexing section 113.

The example shown in FIG. 11 is a case where the proportion of radio resources to assign is made larger, for transmission data of a data block having a larger number of NACKs reported, that is, transmission data of a data block having a larger number of NACKs reported from different terminals, out of data blocks for retransmission to be multiplexed.

As described above, according to the present embodiment, retransmission control section 302 determines radio resources to which data blocks for retransmission are assigned, based on the channel quality of a terminal that has reported a retransmission request. By this means, multiplexing section 113 can assign a data block for retransmission to radio resources having good channel quality of a terminal that has reported a retransmission request, so that it is possible to prevent a retransmission request from being reported again and improve the efficiency of retransmission.

Although a method of assigning radio resources to a data block for retransmission to be multiplexed and arranged in the time slot for retransmission that is described in Embodiment 1, has been described with the above embodiment, it is also possible to apply the radio resource assignment method described in the present embodiment to a data block for retransmission to be multiplexed and arranged in the time slot for retransmission that is described in Embodiment 2.

Further, the above descriptions are examples of preferable embodiments of the present invention and the scope of the present invention is not limited to these.

Further, in the above descriptions, a data block refers to a unit for encoding and decoding, and it is possible to substitute “transport block,” “code ward,” or “packet,” for example, for “data block.” Further, in the above descriptions, “a time slot” refers to a transmission time unit, and it is possible to substitute “subframe” or “frame,” for example for “time slot.”

The disclosure of Japanese Patent Application No. 2009-130869, filed on May 29, 2009, including the specification, drawings and abstract, is incorporated herein by reference in its entirety.

### INDUSTRIAL APPLICABILITY

The present invention is useful, for example, for a base station apparatus, a terminal apparatus, a radio communication system, and a transmission method in an MBMS system.

### REFERENCE SIGNS LIST

100, 100A, 300 Base station
101 Division section
102, 110 Encoding and modulation section
103, 111 Encoding section
104, 112, 115, 115A, 210, 303, 402 Modulation section
106, 202 Radio reception section
105, 201 Antenna
107, 205, 207 Demodulation section
108 Retransmission request detection section
109, 109A, 302 Retransmission control section
113, 113A Multiplexing section
114, 114A Arrangement section
116 Data and control signal multiplexing section
117, 211 Radio transmission section
200, 200A, 400 Terminal
203, 203A Multiplexing information detection section
204, 204A Time slot demultiplexing section
206, 206A Block demultiplexing section
208 Decoding section
209 Error detection section

1. A base station apparatus for transmitting multi-carrier data and/or broadcast data to a plurality of terminal apparatuses per data block at the same time, the base station apparatus comprising:
a reception section that receives a retransmission request signal from each of the plurality of terminal apparatuses;
an encoding and modulation section that encodes and modulates transmission data contained in data blocks that are different from each other, according to the received retransmission request signal, and outputs a plurality of data blocks for retransmission;
a multiplexing section that multiplexes the plurality of data blocks for retransmission and outputs a multiplexed block; and
an arrangement section that arranges the multiplexed block in a time slot for retransmission.

2. The base station apparatus according to claim 1, wherein the arrangement section provides the time slot for retransmission periodically.

3. The base station apparatus according to claim 1, wherein the arrangement section provides the time slot for retransmission, when the number of different data blocks in response to which the retransmission request signal is reported becomes a predetermined number.

4. The base station apparatus according to claim 1, wherein the multiplexing section uses time division multiplexing, frequency division multiplexing, or code division multiplexing.

5. The base station apparatus according to claim 1, further comprising a control section that determines an encoding rate and a modulation level of transmission data contained in the data block in response to which the retransmission request signal is reported,
wherein the encoding and modulation section outputs the data block for retransmission using the determined encoding rate and modulation level.

6. The base station apparatus according to claim 5, wherein the control section lowers the encoding rate or the modulation level of the transmission data of a data block having a larger number of retransmission request signals reported.

7. The base station apparatus according to claim 1, wherein the multiplexing section determines a radio resource to which the data block for retransmission is assigned, based on channel quality of the terminal apparatus that has reported the retransmission request signal.

8. A terminal apparatus comprising:
a reception section that receives a symbol sequence transmitted per data block at the same time from a base station apparatus;
a slot demultiplexing section that demultiplexes a multiplexed block arranged in a time slot for retransmission, from the symbol sequence;
a block demultiplexing section that demultiplexes the multiplexed block into a plurality of data blocks and outputs a data block for retransmission;
a demodulation and decoding section that demodulates and decodes the data block for retransmission and outputs decoded data;
an error detection section that detects whether an error of the decoded data is present or not present; and
a transmission section that transmits a retransmission request signal according to a result of the error detection.

9. A radio communication system comprising:
a base station apparatus that transmits multi-carrier data and/or broadcast data per data block to a plurality of terminal apparatuses at the same time and comprises:
a reception section that receives a retransmission request signal from each of the plurality of terminal apparatuses;
an encoding and modulation section that encodes and modulates transmission data contained in data blocks that are different from each other, according to the received retransmission request signal, and outputs a plurality of data blocks for retransmission;
a multiplexing section that multiplexes the plurality of data blocks for retransmission and outputs a multiplexed block; and
an arrangement section that arranges the multiplexed block in a time slot for retransmission; and
a terminal apparatus that comprises:
a reception section that receives a symbol sequence transmitted per data block at the same time from the base station apparatus;
a slot demultiplexing section that demultiplexes the multiplexed block arranged in the time slot for retransmission, from the symbol sequence;
a block demultiplexing section that demultiplexes the multiplexed block into a plurality of data blocks, and outputs a data block for retransmission;
a demodulation and decoding section that demodulates and decodes the data block for retransmission, and outputs decoded data;
an error detection section that detects whether an error of the decoded data is present or not present; and
a transmission section that transmits the retransmission request signal according to a result of the error detection.

10. A transmission method of transmitting multi-carrier data and/or broadcast data per data block to a plurality of terminal apparatuses at the same time, the method comprising the steps of:
receiving a retransmission request signal from each of the plurality of terminal apparatuses;
encoding and modulating transmission data contained in data blocks that are different from each other, according to the received retransmission request signal, and outputting a plurality of data blocks for retransmission;
multiplexing the plurality of data blocks for retransmission, and outputting a multiplexed block; and
arranging the multiplexed block in a time slot for retransmission.
